(19) United States
(12) Patent Application Publication
(10) Pub. No.: US 2009/0241149 A1
(43) Pub. Date: Sep. 24, 2009

(54) Content reproduction system, remote control device, and computer program

(75) Inventors: Akio Yoshioka, Saitama (JP); Noboru Takahashi, Tokyo (JP)

Correspondence Address: MORRISON & FOERSTER LLP, 425 MARKET STREET, SAN FRANCISCO, CA, 94105-2482, US

(73) Assignee: Access Co., Ltd., Chiyoda-ku, (JP)

(21) Appl. No.: 12/311,136

(22) PCT Filed: Sep. 13, 2007
(86) PCT No.: PCT/JP2007/067797

§ 371 Date: Mar. 18, 2009

(30) Foreign Application Priority Data
Sep. 13, 2007 (JP) 2006-252735

(51) Int. Cl. H04N 7/173

(52) U.S. Cl. 725/87

(57) ABSTRACT

A user uses a DMC (remote control device) 10 to deliver content from a DMS (content server) to a first DMR (content reproducing device) 30a and reproduces the content on the DMR 30a for viewing. When the reproduction is paused by an operation on the DMC 10 while viewing the content, reproduction restart information (at least the content ID and pause position information) is stored in the DMC 10. After that, a second DMR 30b is specified by an operation on the DMC 10, and the reproduction of the content is restarted on the DMR 30b using the stored reproduction restart information beginning at the pause position. This configuration allows the user, with the remote control device, to easily and quickly pause the reproduction of the content on a reproducing device and to restart the reproduction of the content on another reproducing device beginning at the pause position.

### TECHNICAL FIELD

The present invention generally relates to a content reproduction system in which content including moving images and sounds is delivered from a server to a reproducing device for viewing, and more particularly to a system that controls the content reproduction system using a remote control device.

### BACKGROUND ART

Conventionally, for use in a system where plural devices connected via a network work together, a system is proposed that allows a user to specify the devices, which will work together, not via the operation screen but intuitively (see Patent Document 1). More specifically, an example is shown in which the user uses an infrared remote control to forward videos, generated on a television set, to a projector.

Another technique is proposed that allows a user, who has been viewing content on a television set and is going to leave home with a mobile phone terminal, to pause the reproduction of the content on the television set and to send the content from the television set to the mobile phone terminal so that the user can view the rest of the content on the mobile phone terminal according to a user's instruction. (see Patent Document 2).

In addition, a standard specification is being developed recently by an organization called DLNA (Digital Living Network Alliance) for interconnecting digital audio-video devices and personal computers (PCs) on a home network to allow those devices to access data, such as moving images, music, still images, etc. for shared use.

In this specification, the existing standards and the general-purpose protocols are combined.

### Patent Document 1: Japanese Patent Laid-Open Publication No. 2005-204099

### Patent Document 2: Japanese Patent Laid-Open Publication No. 2005-175862

### DISCLOSURE OF THE INVENTION

### Problems to be Solved by the Invention

Meanwhile, a user who is viewing content sometimes wants to move to another place before the content is not yet finished. For example, while viewing content on a first television set at a place in the home (for example, in the living room on the first floor), the user sometimes wants to pause the reproduction and wants to view the rest of the content on a second television set in another place (for example, in the bedroom on the second floor).

To meet this need, a portable video receiver is provided to allow the user to carry one for viewing content in any desired place. However, the inconvenience of such a portable device is that the screen size is small.

It is considered that interconnecting a reproducing device in the home and a server, located away from the reproducing device, that provides content via a home network, such as the one described above, allows the user, who has been viewing content at a first place, to continue viewing the rest of the content at a second place. In this case, however, the user is required to memorize the content viewed at the first place and the position in the content where the reproduction is paused and to select the same content at the second place and fast-forward to the reproduction pause position. This operation is not only complex but also time-consuming and unreliable.

The technique disclosed in Patent Document 2 given above is that content being viewed on a television set in the home is paused and the rest of the content is viewed on a mobile phone terminal. However, this technique is not applicable directly to the case described above in which the viewing of content is paused and is restarted among the reproducing devices located in plural places. In addition, the suspension of content reproduction on a reproducing device is to simply pause the reproduction and so, if the reproduction of the paused content is stopped to view another content or if the power of the reproducing device is once turned off, it becomes difficult to restart the reproduction from the interrupted position.

In view of the foregoing, it is an object of the present invention to provide a content reproduction system, a remote control device, and a computer program that allow a user to pause the reproduction of content on a reproducing device and to restart the reproduction on another reproducing device from the paused position easily and quickly using the remote control device.

### Means to Solve the Problems

A content reproduction system of the present invention comprises a content server in which contents are stored deliverably; a plurality of reproducing devices each of which reproduces content; and a remote control device that controls the content server and the reproducing devices. In this system, the content server starts delivering a specified content to a specified reproducing device according to a delivery instruction from the remote control device and, if a pause instruction is received from the remote control device during the delivery, stops the delivery of the content. The remote control device receives reproduction restart information from the content server in response to the pause instruction to pause the delivery of the content and stores the received reproduction restart information therein, wherein the reproduction restart information includes identification information on a delivery-paused content and information on a pause position. When the reproduction restart information as well as a restart instruction are received from the remote control device, the content server delivers the content to a specified reproducing device beginning at the pause position.

Another content reproduction system of the present invention comprises a content server in which contents are stored deliverably; a plurality of reproducing devices each of which reproduces content; and a remote control device that controls the content server and the reproducing devices. The content server delivers a specified content to a specified reproducing device according to a delivery instruction from the remote control device, the reproducing device starts reproducing the delivered content and, if a pause instruction is received from the remote control device during the reproduction, stops the reproduction. The remote control device receives reproduction restart information from the reproducing device in response to the pause instruction to pause the reproduction of the content and stores the reproduction restart information therein, wherein the reproduction restart information includes identification information on the reproduction-paused content and information on a pause position. When the reproduction restart information as well as a restart instruction are received from the remote control device, any of the reproducing devices acquires the content from the content server and reproduces the content beginning at the pause position.

The configurations described above allow the user, with the use of the remote control device, to specify which content is to be reproduced on which reproducing device and to store the reproduction restart information, which includes content identification information and pause position information, in the remote control device when the reproduction of the content is paused on one reproducing device, thus allowing the user to quickly and reliably reproduction the same content on another reproducing device beginning at the pause position.

A remote control device of the present invention, which selectively controls a plurality of reproducing devices each of which reproduces content delivered from a content server, comprises reproducing device specification means that specifies a reproducing device for reproducing content; content specification means that specifies content to be reproduced; delivery start instruction means that instructs the content server to start a delivery of the specified content on the specified reproducing device; delivery pause instruction means that instructs the content server to pause the delivery of the content to the reproducing device that is reproducing the content reproduction restart information storage means that acquires and stores reproduction restart information including identification information on a delivery-paused content and information on a pause position; restart reproducing device specification means that specifies a reproducing device on which the reproduction of the reproduction-paused content is to be restarted; and delivery restart instruction means that instructs the reproducing device, on which the reproduction is to be restarted, to restart the delivery, beginning at the pause position of the delivery-paused content, based on the stored reproduction restart information.

Another remote control device of the present invention, which selectively controls a plurality of reproducing devices each of which reproduces content delivered from a content server, comprises reproducing device specification means that specifies a reproducing device for reproducing content; content specification means that specifies content to be reproduced; reproduction start instruction means that instructs the specified reproducing device to start a reproduction of the specified content reproduction pause instruction means that instructs the reproducing device, which is reproducing content, to pause the reproduction of the content; reproduction restart information storage means that acquires and stores reproduction restart information including identification information on a delivery-paused content and information on a pause position; restart reproducing device specification means that specifies a reproducing device on which a reproduction of the reproduction-paused content is to be restarted; and reproduction restart instruction means that instructs the reproducing device, on which the reproduction is to be restarted, to restart the reproduction, beginning at the pause position of the reproduction-paused content, based on the stored reproduction restart information.

The present invention is implemented also as a computer program, which is executed on a remote control device selectively controlling a plurality of reproducing devices each of which reproduces content, or as a recording medium storing the computer program therein.

### EFFECTS OF THE INVENTION

According to the present invention, the user can use a remote control device to easily and quickly perform the operation in which the reproduction of content on one reproducing device is paused and the reproduction is restarted on another reproducing device beginning at the pause position. This improves the ease of use of the remote control device in a content reproduction system.

### BRIEF DESCRIPTION OF THE DRAWINGS

FIG. 1 is a diagram showing the general system configuration of a content reproduction system of the present invention.

FIG. 2 is a diagram showing an example of the hardware configuration of a DMC shown in FIG. 1.

FIG. 3 is a diagram showing an example of the hardware configuration of a DMS shown in FIG. 1.

FIG. 4 is a block diagram showing an example of the configuration of a monitor device that is an example of a DMR shown in FIG. 1.

FIG. 5 is a block diagram showing the functions of the DMC in an embodiment of the present invention.

FIG. 6 is a diagram showing an example of the configuration of reproduction restart information stored in the DMC in the embodiment of the present invention.

FIG. 7 is a diagram showing an example of the configuration of other reproduction restart information in the embodiment of the present invention.

FIG. 8 is a diagram showing some examples of how to specify the DMR by means of the DMC in the embodiment of the present invention.

FIG. 9 is a flowchart showing an example of processing performed when a content reproduction instruction is issued by the DMC according to the user operation in the embodiment of the present invention.

FIG. 10 is a flowchart showing an example of processing performed when a content reproduction pause instruction is issued by the DMC according to the user operation in the embodiment of the present invention.

FIG. 11 is a flowchart showing an example of processing performed when a content reproduction restart instruction is issued by the DMC according to the user operation in the present invention of the present invention.

FIG. 12 is a diagram showing an example of the user interface on the DMC display screen for restarting the reproduction in the embodiment of the present invention.

FIG. 13 is a diagram showing another example of the user interface similar to that in FIG. 12.

FIG. 14 is a diagram showing the configuration of a system in a second embodiment of the present invention.

### BEST MODE FOR CARRYING OUT THE INVENTION

Preferred embodiments of the present invention will be described in detail below with reference to the drawings.

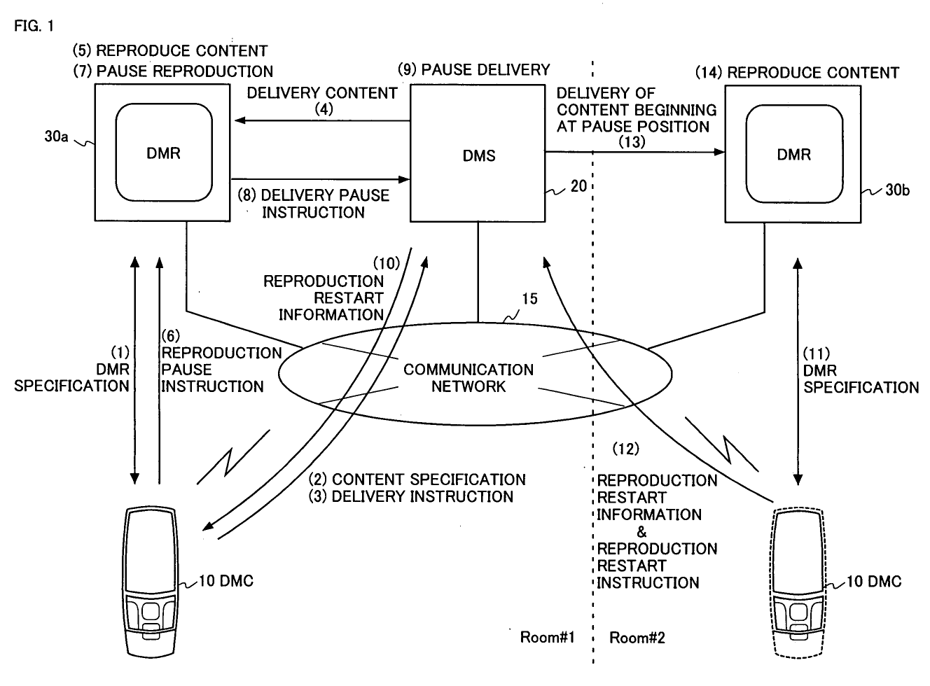

FIG. 1 is a diagram showing the general system configuration of a content reproduction system of the present invention. This system comprises at least one DMC (Digital Media Controller) 10, at least one DMS (Digital Media Server) 20, and at least two DMRs (Digital Media Renderer) 30a and 30b, all of which are interconnected via a communication network 15.

Although composed primarily of moving images (or motion pictures) and sounds, the content used in this embodiment is not limited to this type of data but may be any time-varying data.

The DMC (Digital Media Controller) 10 is a device having the function of a remote controller (or remote control device) for controlling the DMS 20 and the DMR 30 (i.e. generic numeral of 30a and 30b). A mobile phone terminal may also have this function.

The DMS (Digital Media Server) 20 is a server device (hereinafter simply called a server) in which contents are stored for delivery to any DMR 30.

The DMRs (Digital Media Renderer) 30a and 30b are devices for reproducing content, for example, monitor devices each including a display device. Information may be sent and received between the DMR 30 and the DMS 20 via the communication network 15 or via the interface that directly connects the both. Unlike a DMP (Digital Media Player) not shown, the DMR (Digital Media Renderer) is a reproducing device having no user interface for content selection or reproduction. The DMR is controlled by the DMC. In FIG. 1, the DMR 30 may be replaced by the DMP which is controlled by the DMC. Alternatively, the DMS 20 may also have the function of the DMP.

The communication network 15 is a network, such as a LAN via which the devices in the home are interconnected, and is implemented by the short distance wireless communication technology (for example, a wireless LAN, Bluetooth™). The network may include a wired connection part.

The operation of the system shown in FIG. 1 will be described below.

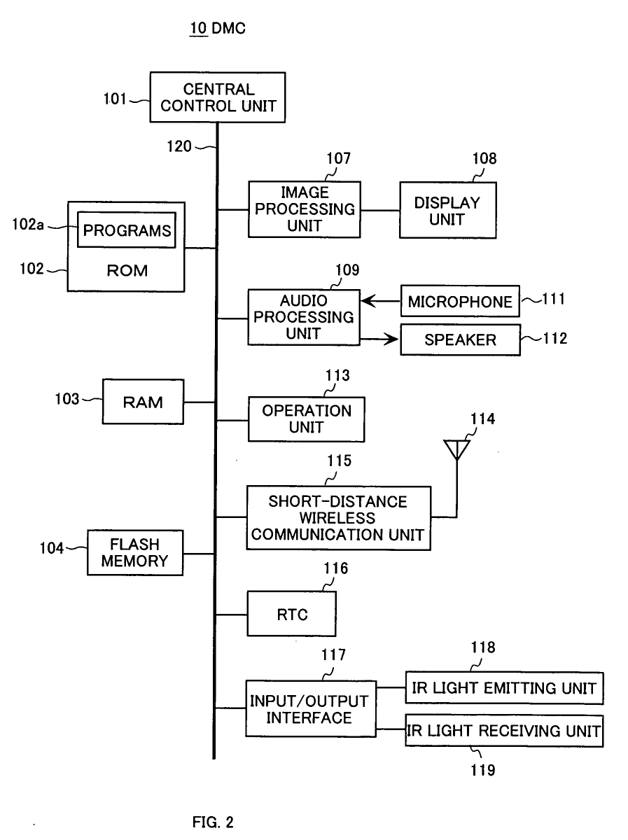

FIG. 2 is a diagram showing an example of the hardware configuration of the DMC 10. The DMC 10 is controlled by the program in a central control unit (for example, CPU) 101. The central control unit 101 is connected to other components via a bus 120. ROM 102 is typically a read-only memory in which the control program for the DMC, initially-installed application programs, and permanent data are stored. RAM 103 is a readable and writable memory in which temporary data-saving areas and work areas are provided. A flash memory 104 is a rewritable memory in which various types of data described above are stored non-volatilely. Programs 102a are stored in the ROM 102 (may also be stored in the flash memory 104). The application programs (computer programs) for the DMC in this embodiment may be pre-installed or may be downloaded later. An image processing unit 107, controlled by the central control unit 101, draws various types of information for display on the display screen of a display unit (including a display device) 108. An audio processing unit 109, connected to a microphone 111 and a speaker 112, performs audio processing under control of the central control unit 101. An operation unit 113 is a part acting as an input interface including keys such as a ten-key pad keys and cursor movement operation keys. A short-distance wireless communication unit 115, connected to an antenna 114, carries out short-distance wireless communication under control of the central control unit 101 and provides the communication function for a wireless LAN, Bluetooth™, and so on. RTC 116 is a real-time clock that provides the function of a clock and a timer. An input/output interface 117 sends and receives signals to and from an IR (Infrared) light emitting unit 118 and an IR light receiving unit 119 under the control of the central control unit 101.

In the case of a mobile phone terminal, the DMC 10 may further comprise a wireless network interface, not shown, for communicating sounds and data wirelessly with a base station via the antenna.

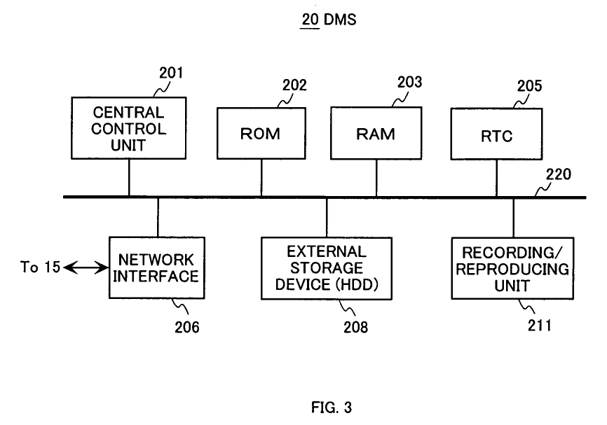

FIG. 3 is a diagram showing an example of the hardware configuration of the DMS 20. The DMS 20 is controlled by the programs in a central control unit (for example, CPU) 201. The central control unit 201 is connected to other components via a bus 220. ROM 202 is typically a read-only memory in which the startup program for starting the DMS 20 and necessary permanent data are stored. RAM 203 is a readable and writable memory in which temporary data-saving areas and work areas are provided. RTC 205 is a real-time clock that provides the function of a clock and a timer. A network interface 206, connected to the communication network 15, provides the communication function. An external storage device 208 is a large-capacity storage device in which programs and content data are stored non-volatilely. The external storage device 208, though typically a hard disk drive (HDD), may be some other storage device such as a DVD. A recording reproducing unit 211 is a part that reproduces content from the external storage device 208 or records externally-supplied content onto the external storage device 208. In addition, a broadcast receiving device for receiving television broadcasting, not shown, may be provided.

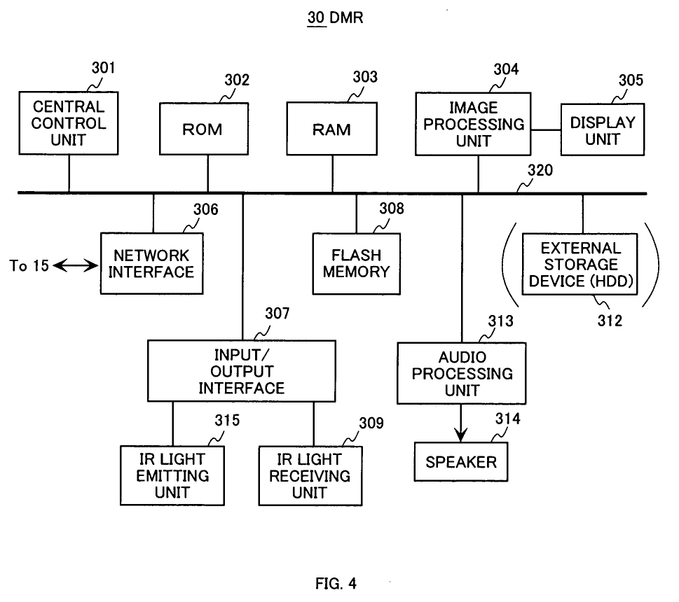

FIG. 4 is a block diagram showing an example of the configuration of a monitor device that is an example of the DMR 30. This monitor device is controlled trough the execution of programs by a central control unit (CPU) 301. The central control unit 301 is connected to external devices via a bus 320. ROM 302 is typically a read-only memory in which the control program for the monitor, initially-installed application programs, and permanent data are stored. RAM 303 is a readable and writable memory in which temporary data-saving areas and work areas are provided. An image processing unit 304 has the function to perform the image processing for content, received via a network interface 306, for displaying the content on a display unit 305. The display unit 305, any display device such as a liquid crystal display device, a CRT display device, or a plasma display device, has the function to optically display the screen based on the signals from the image processing unit 304. The network interface 306 has the function to establish the connection to the communication network 15 and send and receive data. An IR light emitting unit 315 and an IR light receiving unit 309 are connected to an input/output interface 307. The IR light emitting unit 315 is capable of generating an infrared signal that is the wireless signal including the device identification information (ID) and so on. The IR light receiving unit 309 has the function to convert the infrared signal, issued from the DMC 10, to the electrical signal and passes the converted electrical signal to the input/output interface 307. A flash memory 308 is a rewritable memory in which various types of data described above are stored non-volatilely. An audio processing unit 313, connected to a speaker 314, performs the audio processing under control of the central control unit 301. In addition, a microphone, which is not shown and is connected to the audio processing unit 313, may be provided. Although not always required, a large-capacity external storage device 312, such as a hard disk drive or a DVD device, may be provided. In addition, a broadcast receiving unit, not shown, for receiving a television broadcast may be provided.

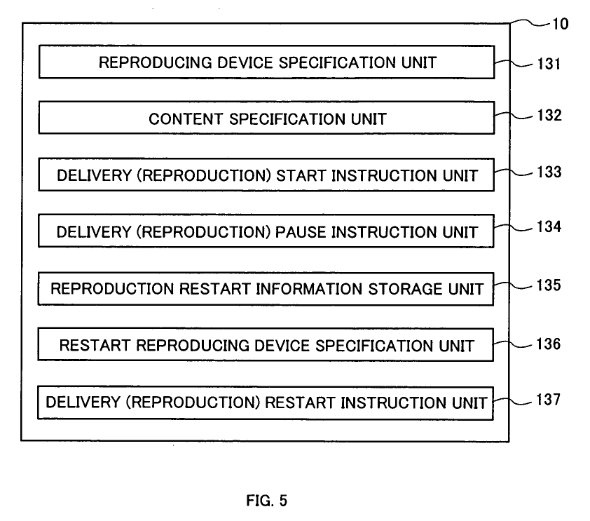

FIG. 5 is a block diagram showing the functions of the DMC 10 in this embodiment. Each function is implemented by a central control unit 101 and by the hardware units and software required for each function. A reproducing device specification unit 131 is a functional unit used by the user to specify a specific DMR 30 as the reproducing device. Various types of “specification unit” and “instruction unit” described below can be implemented by the operation unit 113 as well as other units such as IR light emitting unit 118, IR light receiving unit 119, and short-distance wireless communication unit 115. A content specification unit 132 is a functional unit that specifies a specific content to be reproduced. A delivery (reproduction) start instruction unit 133 is a functional unit that is used to give an instruction to start the delivery (and/or reproduction) of a specified content. A delivery (reproduction) pause instruction unit 134 is a functional unit that is used to give an instruction to pause the delivery (and/or reproduction) of the content being delivered (and/or reproduced). A reproduction restart information storage unit 135 is a storage unit in which reproduction restart information is temporarily stored and, for example, a recording area in the RAM 113 or the flash memory 104 is used. A restart reproducing device specification unit 136 is a functional unit that specifies a specific DMR 30 as the reproducing device for restarting the reproduction of the reproduction-paused content. A delivery (reproduction) restart instruction unit 137 is a functional unit that gives an instruction to restart delivery (and/or reproduction).

The following describes the general operation of the system in this embodiment by referring again to FIG. 1. In the example in FIG. 1, the delivery of content from the DMS 20 is based on the streaming technique, and the DMR 30(30a, 30b) sequentially processes delivered content data for reproducing in the streaming mode. That is, the DMR 30 does not download all of delivered content data once for storage but serially reproduces received content parts to enable the reproduction of content to be started immediately after the start of delivery without waiting for all data of the content to be received.

For example, assume that the user is going to view a particular content, which is provided by the DMS 20, on the DMR 30a in the living room (Room#1) on the first floor. In this case, the user first specifies a DMR 30a (1). Although the infrared interface is used in the example in the figure, the user can use one of various methods for specifying the DMR as will be described below.

Next, the user specifies the content to be reproduced (2). In the example in the figure, the user accesses the DMS 20 from the DMC 10 via the communication network 15 and selects a desired content from the display of the content list (not shown). The specification order of the contents and the DMR 30 may be reversed. If the DMR 30 is specified first, the content may also be selected from the DMS 20 via the DMR.

After the content and the DMR 30 are specified, the DMC 10 issues a content delivery instruction to the DMS 20 according to the instruction from the user (3). This delivery instruction may also be issued from the DMC 10 via the DMR 30.

DMS 20 delivers the specified content to the specified DMR 30 (DMR 30a in this example) according to the delivery instruction (4). Upon receipt of this delivery, the DMR 30a reproduces the content (5).

At this time, assume that the user wants to pause the viewing of the content in the living room and to continue to view the rest of the content in the bedroom (Room #2) on the second floor. To do so, the user operates the DMC 10 to issue an instruction to the DMR 30a via the infrared interface or the communication network 15 to pause the reproduction of the content being reproduced. In response to this instruction, the DMR 30a stops the reproduction of the content (7) and instructs the DMS 20 to pause the delivery of the content (8).

The DMS 20, which receives the delivery pause instruction, stops the content delivery operation (9) and, at the same time, sends the reproduction restart information, including at least the content identification information (ID) and the pause position information, to the DMC 10 via the communication network 15 (10). If there are plural DMSs, the restart reproduction information includes the DMS identification information (server ID). The pause position information is information for identifying the content pause position at which the reproduction is paused, for example, the frame number of the pause point or the reproduction time relative to the start of the content.

Then, the user moves to the bedroom on the second floor with the DMC 10 and operates the DMC 10 to specify the DMR 30b (11). Next, in response to the instruction from the user, the DMC 10 sends the internally-stored reproduction restart information, as well as a reproduction restart instruction, to the DMS 20 via the communication network 15 (12). This reproduction restart instruction may also be sent via the DMR 30b through the infrared interface or the communication network 15. In response to the reproduction restart instruction, the DMS 20 delivers the content beginning at the pause position specified by the pause position information (13). The DMR 30b reproduces the delivered content (14).

Although the DMR 30a and the DMR 30b are located in separate rooms in the above example, they may be located at separate positions in the same room. They may also be located in separate rooms on the same floor.

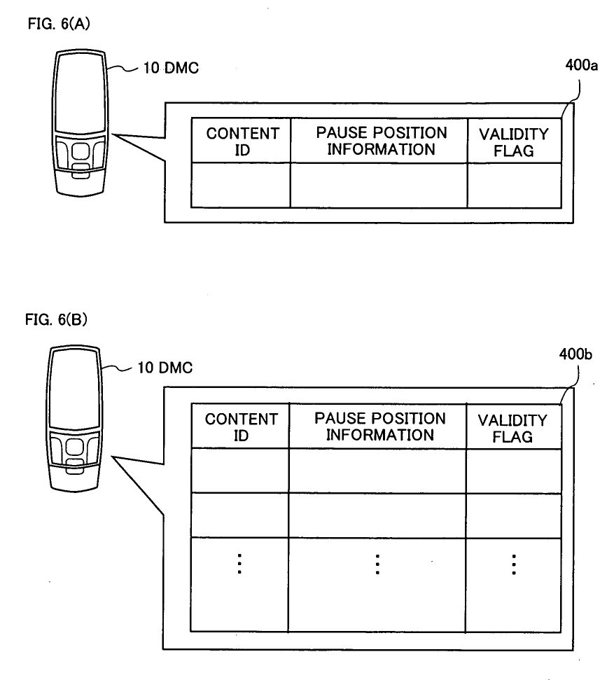

FIG. 6 is a diagram showing an example of the configuration of the reproduction restart information stored in the DMC 10. FIG. 6(a) shows reproduction restart information 400a composed of only one record that stores “content ID” that is content identification information, “pause position information” that indicates the pause position at which the reproduction was paused, and “validity flag” that indicates whether or not this reproduction restart information is valid. When the reproduction of once-started content is paused halfway through, the content ID and the pause position information are recorded and the validity flag is turned on. After that, when the reproduction of this content is restarted or the user explicitly specifies the restart, the validity flag is turned off. If the content ID and the pause position information are erased when the record is invalidated, there is no need for the validity flag.

FIG. 6(b) shows an example of another type of reproduction restart information 400b. The reproduction restart information 400a stores only one record while reproduction restart information 400b can store plural records. This configuration allows the reproduction of plural contents to be paused at the same time. In this case, however, the user is required to select which content to restart when the reproduction is restarted.

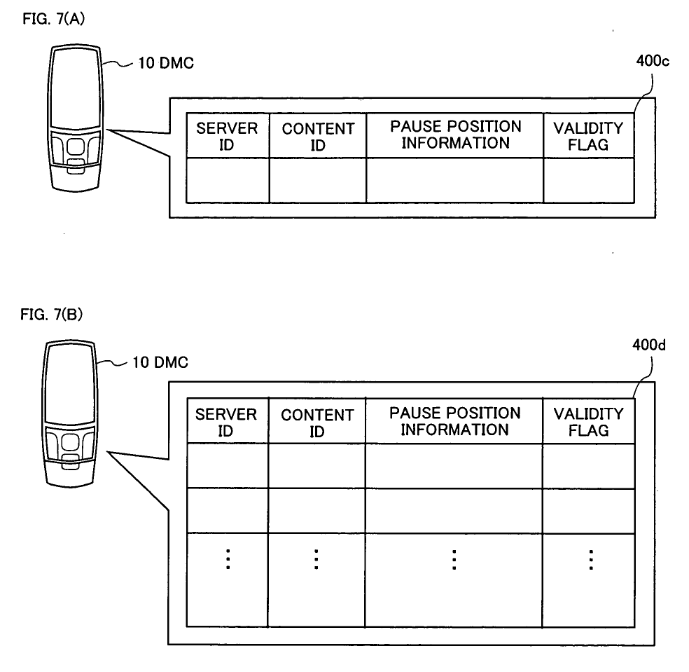

FIG. 7 shows an example of the configuration of still another reproduction restart information 400c and 400d that are used when there are plural DMSs in the system. FIGS. 7(a) and 7(b) correspond to FIGS. 6(a) and 6(b) respectively and, on the premise that there are plural DMSs, each record of the reproduction restart information 400c and 400d has a field “server ID” that is added to each record of the reproduction restart information 400a and 400b as the DMS identification information.

This embodiment gives the following effects.

First, because the content ID and the pause position information are stored as the reproduction restart information when the viewing of content is paused, the user can issue a reproduction restart instruction without concerning about the content ID of the content and the pause position. There is no need for the DMS 20 to pause the delivery of the content.

In addition, the reproduction restart information, which is stored in the DMC 10, makes the control simple. It is also possible to store the reproduction restart information not in the DMC 10 but in the DMS 20. In this case, however, if there are plural DMSs 20, the user must select one of the DMSs 20 when the restart instruction is issued. The problem in this case is that the user has no way to know which DMS 20 stores the information on the content paused by the user. In addition, if one of the DMSs 20 is turned off, the menu for selecting the content to be restarted cannot be displayed until all DMSs 20 become turned on. Storing the reproduction restart information in the DMC 10 will avoid this problem.

In addition, when the DMC 10 is configured by a mobile phone terminal, the user can use his or her own mobile phone terminal to issue an instruction to reproduction, pause, or restart the content. In this case, too, storing the reproduction restart information in the DMC 10 means that the reproduction restart information is stored individually in the mobile phone of each user, making it easy to manage the reproduction restart information on a user basis.

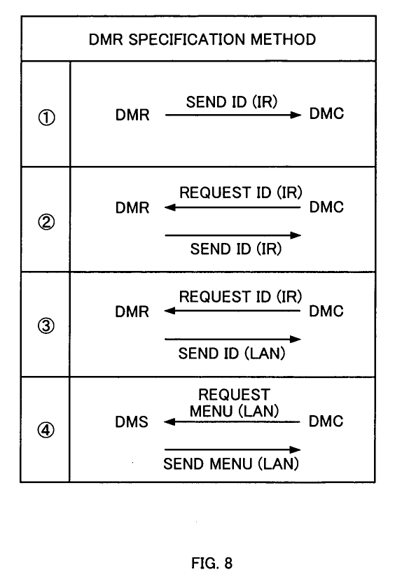

Next, by referring to FIG. 8, the following gives some examples showing how to specify the DMR 30 by means of the DMC 10.

In the first method, each DMR outputs a directional wireless signal, for example, an infrared light, to send its identification information (ID) in the forward direction periodically. The DMC placed in front of, and oriented toward, the desired DMR receives the identification information to identify the DMR.

In the second method, the DMC sends an infrared light to a desired DMR to request the DMR to return the ID and, upon receiving the ID from the DMR, identifies the DMR.

In the third method, the DMC sends an infrared light to a desired DMR to request the DMR to return the ID and, upon receiving the ID from the DMR via the communication network 15, identifies the DMR.

In the fourth method, the DMC requests the DMS to return the menu including a list of DMRs via the communication network 15 and selects a desired DMR from the menu returned from the DMS via the communication network 15.

In the first to third methods, the user performs the operation with the specification unit of the DMC oriented toward a desired DMR and, so, those methods have the advantage that the user can specify a DMR intuitively and simply. The fourth method has the advantage that the user can specify a desired DMR even at a place distant from the DMR (at a place where DMR cannot be seen).

Note that those DMR specification methods are exemplary only and the present invention is not limited to one of them.

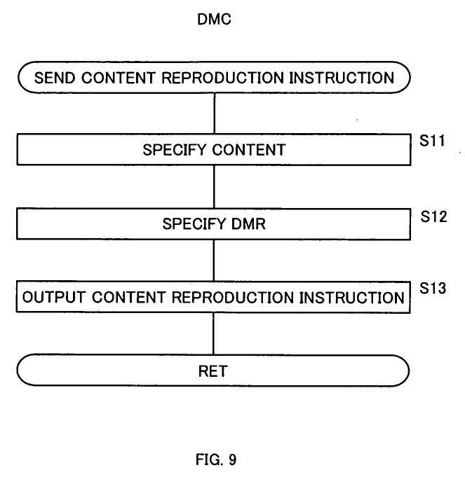

FIG. 9 is a flowchart showing an example of processing performed when a content reproduction instruction is issued by the DMC according to the user operation. First, the DMC specifies the content to be reproduced (S11). The DMC specifies a DMR, which will reproduction the content, in one of the methods described in FIG. 8 (S12). The specification order of the content and the DMR may be reversed. Next, the DMC outputs a content reproduction instruction (S13). This processing delivers the specified content from the DMS 20 to the DMR where the reproduction of the content is started.

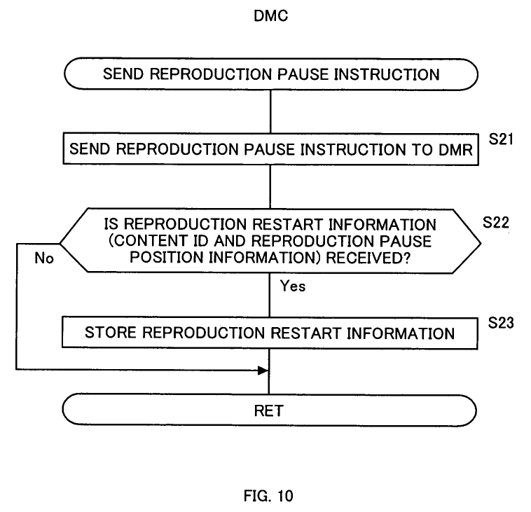

FIG. 10 is a diagram showing an example of processing performed when a content reproduction pause instruction is issued by the DMC according to the user operation. First, DMC sends a reproduction pause instruction to the DMR, which is reproducing the content, according to the user operation (S21). If the content is being reproduced, the reproduction restart information (content ID of the content being reproduced and the pause position information) is sent from the DMS (or DMR). If the reproduction restart information is received (S22, Yes), the DMC stores it in the internal memory (S23). In the example shown in FIG. 6, the “validity flag” is turned on. If the reproduction restart information is not received within a predetermined time from the time the reproduction pause instruction is issued, the processing is terminated.

Although it is assumed in this processing example that the delivery pause instruction is issued from the DMR to the DMS, the pause instruction may be issued from the DMC directly to the DMS.

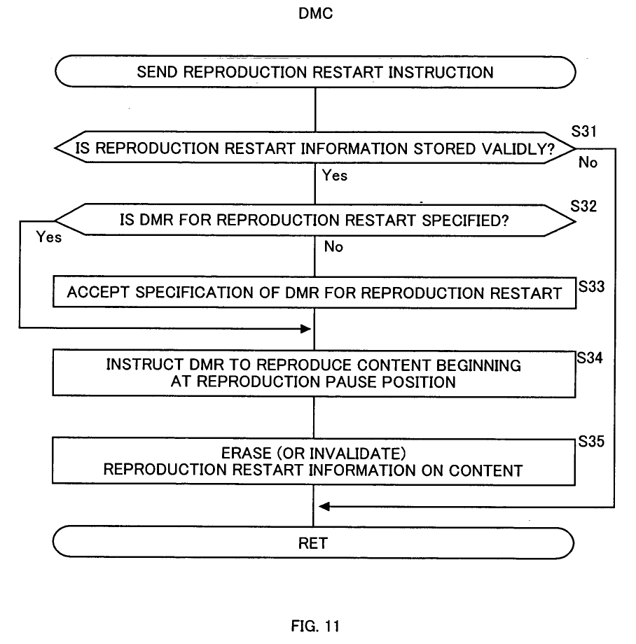

FIG. 11 is a diagram showing an example of processing performed when a content reproduction restart instruction is sent by the DMC according to the user operation. First, the DMC checks if the reproduction restart information is stored validly (S31). If the reproduction restart information is not stored or if the reproduction restart information is stored but the validity flag is off, the processing is terminated. If the reproduction restart information is stored validly, the DMC checks if the DMR for restarting the reproduction is specified (S32). If it is specified, control is passed to step S34. If it is not specified, the DMC prompts the user to specify the DMR for restarting the reproduction and accepts the operation (S33). After that, the DMC instructs the DMR to restart reproducing the content at the paused position based on the reproduction restart information (S34). If plural pieces of valid reproduction restart information are stored, the DMC requests the user to specify one of them. After that, the DMC erases or invalidates the reproduction restart information on the content (S35).

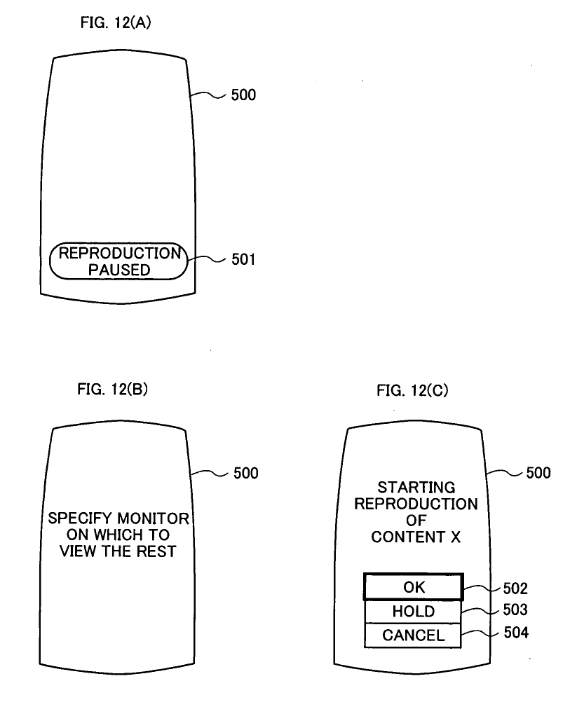

FIG. 12 is a diagram showing an example of the user interface on the DMC display screen for restarting the reproduction. FIG. 12(a) shows an example of the screen for informing the user that, after the reproduction of the content is paused, the reproduction restart information is stored and, in this example, a button (or icon) 501 is displayed to indicate the condition. When the user presses this button 501, the message such as the one shown in FIG. 12(b) is displayed to prompt the user to specify a monitor (DMR) on which the user can view the rest of the content (that is, on which the reproduction is to be restarted). When the DMR is specified in the method described above, the menu related to the restart of the reproduction of the paused content is displayed as shown in FIG. 12(c). When the “OK” button 502 in the menu is pressed, the reproduction is restarted. When the “Hold” button is pressed, the reproduction is not restarted but the screen is closed. When the “Cancel” button is pressed, the reproduction restart information (FIG. 6 and FIG. 7) on the content is deleted and the screen is closed. Instead of this configuration, it is also possible to omit the display of the screen shown in FIG. 12(c) and to restart the reproduction of the content immediately after the monitor is specified.

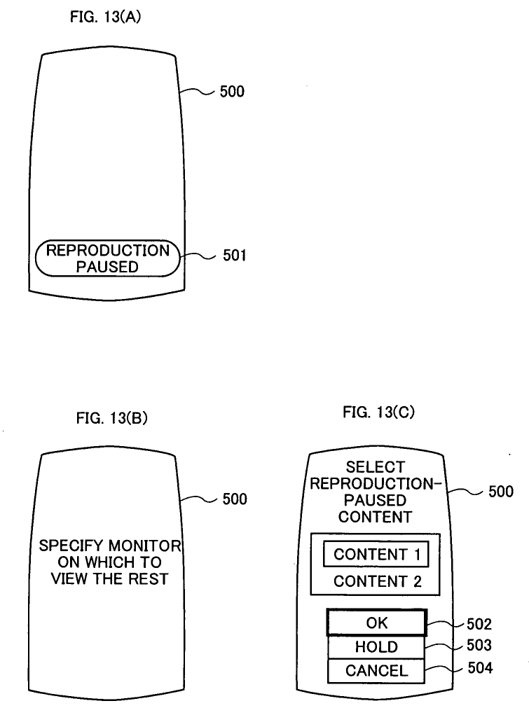

FIG. 13 shows another example of the user interface similar to that in FIG. 12. FIG. 12 shows an example in which there is one reproduction-paused content while FIG. 13 shows an example in which there are plural reproduction-paused contents and the user is requested to select one of them. The others are the same as those in FIG. 12.

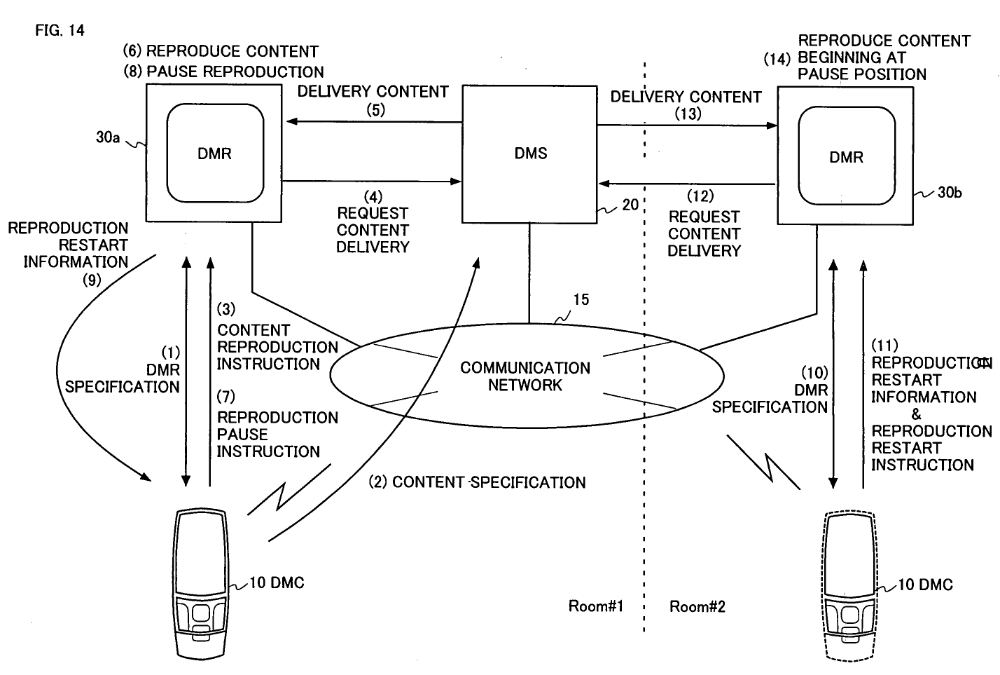

FIG. 14 shows the configuration of a system in a second embodiment of the present invention. In the embodiment shown in FIG. 1, the delivery of content from a DMS 20 is based on streaming reproduction. In contrast, the system in FIG. 14 is based on content downloading.

As in the example described above, assume that the user is going to view a particular content, which is provided by the DMS 20, in the living room (Room#1) on the first floor via a DMR 30a. In this case, the user first specifies the DMR 30a (1). Next, the user specifies content to be reproduced (2).

After the content and the DMR are specified, a DMC 10 issues a content reproduction instruction to the DMR 30a according to an instruction from the user (3).

In response to this reproduction instruction, the DMR 30a issues a request to deliver the specified content (4). The DMS 20, which receives this delivery request, delivers the content to the DMR 30a (5). The DMR 30a, which receives this delivery, starts reproducing the content after receiving all content data (6).

At this time, assume that the user wants to pause the viewing of the content in the living room and to continue to view the rest of the content in the bedroom (Room #2) on the second floor. To do so, the user operates the DMC 10 to issue an instruction to the DMR 30a via the infrared interface or a communication network 15 to pause the reproduction of the content being reproduced (7). In response to this instruction, the DMR 30a stops the reproduction of the content (8).

The DMR 30a, which receives the reproduction pause instruction, sends reproduction restart information, which includes at least identification information (ID) on the content and the pause position information, to the DMC 10 via the infrared interface or the communication network 15 (9).

After that, the user moves to the bedroom on the second floor with the DMC 10 and operates the DMC 10 to specify a DMR 30b (10). Next, in response to the instruction from the user, the DMC 10 sends the internally-stored reproduction restart information, as well as a reproduction restart instruction, to the DMR 30b via the infrared interface or the communication network 15 (11). The DMR may be specified after the reproduction instruction is issued. In response to this reproduction restart instruction, the DMR 30b requests the DMS 20 to deliver the content (12). In response to this request, the DMS 20 delivers the content to the DMR 30b (13). The DMR 30b once internally stores the delivered content and restarts reproducing the content beginning at the pause position specified by the reproduction restart information (14).

In this embodiment, whether the content once downloaded to the DMR 30 is automatically erased or saved after the reproduction is not important to the present invention; that is, the content may be erased or saved.

While the preferred embodiments of the invention have been described, it is to be understood that the present invention is not limited to those described above but changes and variations may be made.

1. A content reproduction system comprising:
a content server in which contents are stored deliverably;
a plurality of reproducing devices each of which reproduces content; and
a remote control device that controls said content server and said reproducing devices;
wherein, said content server starts delivering a specified content to a specified reproducing device according to a delivery instruction from said remote control device and, if a pause instruction is received from said remote control device during the delivery, stops the delivery of the content,
said remote control device receives reproduction restart information from said content server in response to the pause instruction to pause the delivery of the content and stores the received reproduction restart information therein, said reproduction restart information including identification information on a delivery-paused content and information on a pause position, and
when the reproduction restart information as well as a restart instruction are received from said remote control device, said content server delivers the content to a specified reproducing device beginning at the pause position.

2. A content reproduction system comprising:
a content server in which contents are stored deliverably;
a plurality of reproducing devices each of which reproduces content; and
a remote control device that controls said content server and said reproducing devices;
wherein, said content server delivers content specified by said remote control device to a reproducing device specified by said remote control device according to a reproduction instruction from said remote control device,
said reproducing device starts reproducing the delivered content and, if a pause instruction is received from said remote control device during the reproduction, stops the reproduction,
said remote control device receives reproduction restart information from said reproducing device, which responds to the pause instruction to pause the reproduction of the content, and stores the reproduction restart information therein, said reproduction restart information including identification information on the reproduction-paused content and information on a pause position, and
when the reproduction restart information as well as a restart instruction is received at any of said reproducing devices from said remote control device, said reproducing devices acquire the content from said content server and reproduces the content beginning at the pause position.

3. (canceled)

4. (canceled)

5. (canceled)

6. (canceled)

7. A remote control device that selectively controls a plurality of reproducing devices each of which reproduces content delivered from a content server, said remote control device comprising:
a reproducing device specification unit that specifies a reproducing device for reproducing content;
a content specification unit that specifies content to be reproduced;
a reproduction start instruction unit that instructs said specified reproducing device to start a reproduction of the specified content;
a reproduction pause instruction unit that instructs said reproducing device, which is reproducing content, to pause the reproduction of the content;
a reproduction restart information storage unit that acquires and stores reproduction restart information including identification information on a delivery-paused content and information on a pause position;
a restart reproducing device specification unit that specifies a reproducing device on which a reproduction of the reproduction-paused content is to be restarted; and
a reproduction restart instruction unit that instructs said reproducing device, on which the reproduction is to be restarted, to restart the reproduction, beginning at the pause position of the reproduction-paused content, based on the stored reproduction restart information.

8. The remote control device according to claim 7, further comprising a unit that, after the reproduction of the content is paused, displays an icon for informing a user that the reproduction restart information is stored.

9. The remote control device according to claim 8 wherein, in response to a user specification for the icon, a message is displayed to prompt the user to specify the reproducing device, on which the reproduction is to be restarted and, when the reproducing device is specified, said reproduction restart instruction unit instructs the specified reproducing device to restart the reproduction of the paused content.

10. The remote control device according to claim 9 wherein the icon is erased after the restart of the reproduction of the paused content is instructed.

11. (canceled)

12. A computer program embodied on a computer-readable medium, and executed on a remote control device that selectively controls a plurality of reproducing devices each of which reproduces content, said computer program causing a computer to execute the steps of:
specifying a reproducing device for reproducing content;
specifying content to be reproduced;
instructing said specified reproducing device to start a reproduction of the specified content;
instructing said reproducing device, which is reproducing content, to pause the reproduction of content;
acquiring and storing reproduction restart information including identification information on reproduction-paused content and information on a pause position;
specifying a reproducing device on which a reproduction of the reproduction-paused content is to be restarted; and
instructing said reproducing device, on which the reproduction is to be restarted, to restart the reproduction, beginning at the pause position of the reproduction-paused content, based on the stored reproduction restart information.
